(19) United States
(12) Patent Application Publication
(10) Pub. No.: US 2013/0098598 A9
(43) Pub. Date: Apr. 25, 2013

(54) METHOD AND APPARATUS FOR SINGLE-LOOP TEMPERATURE CONTROL OF A COOLING METHOD

(71) Applicant: Shawn A. Hall, Yorktown Heights, NY (US)

(72) Inventor: Shawn A. Hall, Yorktown Heights, NY (US)

(73) Assignee: INTERNATIONAL BUSINESS MACHINES CORPORATION, Armonk, NY (US)

(21) Appl. No.: 12/483,542

(22) Filed: Jun. 12, 2009

Related U.S. Application Data
(63) Continuation-in-part of application No. 11/939,165, filed on Nov. 13, 2007, now abandoned.

(51) Int. Cl. G05D 23/00; F28F 13/00; G05D 7/00; F28F 13/06

(52) U.S. Cl. 165/293; 165/103; 165/111; 700/282

(57) ABSTRACT

An apparatus for cooling N heat-producing devices, where AT is an integer no smaller than one, using a cooling fluid that may be supplied at a temperature below the dew-point temperature of ambient air. To avoid condensation on the heat-producing devices, the cold fluid is warmed, upstream of the heat-producing devices, to a temperature T₀ that is above the dew-point. The warming is accomplished, in a heat exchanger, by the warm fluid returning from the heat-producing devices. The amount of warming is controlled by periodically measuring T₀ as well as the N temperatures downstream of the N heat-producing devices, and sending these N+1 temperature measurements to a control element that implements a control algorithm whose purpose is to achieve a set-point value of T₀ by regulating, via N control valves, the flow of fluid to the N heat-producing devices. Also provided is a method for cooling the N heat-pro during devices pursuant to the inventive apparatus by a temperature control over the cooling fluid.

This invention was made with U.S. Government support under Contract No. B554331 awarded by the Department of Energy, in view of which the U.S. Government has certain rights to this invention.

The present invention is related to devices for cooling heat-producing devices, and more specifically, is related to devices for pre-treating a fluid coolant in order to control the temperature thereof. Moreover, the invention also pertains to methods for cooling the heat-producing devices.

### BACKGROUND

In the current state-of-the-technology, the concepts of direct liquid-cooling and liquid-assisted air cooling are well-known for the purposes of cooling heat-producing devices, as disclosed, for example, in U.S. Pat. No. 7,486,513 issued on Feb. 3, 2009 entitled “Method and Apparatus for Cooling an Equipment Enclosure Through Closed-Loop, Liquid-Assisted Air Cooling in Combination with Direct Liquid Cooling”, and co-pending U.S. patent application Ser. No. 11/939,165, filed on Nov. 13, 2007, entitled “Water-Assisted Air Cooling for a Row of Cabinets”, both of which are commonly assigned to the present assignee, and the disclosures of which are incorporated herein in their entireties. In direct-liquid-cooling systems, liquid coolant flows in pipes or passages embedded in coolers that lie in direct or proximal contact with heat-producing devices; in such systems, heat transfer from the electronics occurs by conduction through the cooler material and by convection to the liquid. In liquid-assisted air cooling, liquid coolant flows in pipes or other passages that are in direct contact with an array of fins positioned at some convenient distance from the heat-producing devices; in such schemes, heat transfer occurs first by convection from the heat-producing devices to air, then by convection from air to the fins, then by conduction through the fins and pipes, and finally by convection to the liquid, thereby cooling the air so that it may, if desired, be re-used to cool more heat-producing devices.

In both systems, i.e., direct liquid cooling and liquid-assisted air cooling, it is important that the liquid flowing to coolers and air-to-liquid heat exchangers be temperature controlled. In particular, if the incoming liquid is too cold—specifically, below the dew-point temperature of ambient air—water in the air will condense on the cold surfaces of coolers and heat exchangers as droplets that may break off under the forces of gravity or air motion. If these water droplets land, for example, on nearby electronics, this may lead to electrical shorting and result in other damage. It is thus an important objective for liquid-cooled systems—in fact, for any fluid-cooled system, whether the fluid be liquid or gaseous—to avoid condensation on cooling equipment by careful temperature control of the incoming coolant.

The invention solves the problem of temperature control of a cooling fluid (e.g., chilled water) typically used to cool one or more heat-producing devices. Temperature control is required in order to prevent condensation on or near the heat-producing devices caused by the cooling fluid being too cold (which chilled water typically is in spring and summer). The known solution is: (1) to create a secondary loop of fluid that is isolated from the primary, chilled-water loop, (2) to pass heat from the secondary loop to the primary loop through a heat exchanger, (3) to control the temperature of the fluid in the secondary loop by modulating the flow of coolant in the primary loop. The drawbacks of this solution are: (a) the secondary loop requires pumps that are large, prone to failure and consume energy, (b) the secondary loop must be separately filled and maintained, (3) the secondary-loop pumps typically pump at all times the amount of water required to cool the worst-case heat load, even though in reality the heat load may vary substantially over time, which wastes pumping energy.

The minimum allowable coolant temperature depends on the particular application. For computer data centers, for example, in “Thermal Guidelines for Data Processing Environment”, ISBN 1-931862-43-5, incorporated herein in its entirety by reference, the American Society of Heating, Refrigeration, and Air-Conditioning Engineers (ASHRAE) has defined various “Classes” of data-processing centers. In a “Class 1” environment, for example, the maximum allowable dew-point is 17° C., so the minimum safe temperature for a coolant is considered to be 18° C. Unfortunately, in many data-processing centers, the only type of coolant available in sufficient quantity is 7° C. chilled liquid (often chilled water) used for air conditioning. In such cases, the 7° C. liquid must be “conditioned” to produce 18° C. liquid. The latter, temperature-controlled liquid may men be safely sent to data-processing equipment, or to other heat-producing devices, that use direct liquid cooling or liquid-assisted air cooling.

### SUMMARY

The invention achieves temperature control of cooling fluid in a single loop by warming the incoming fluid, if it is too cold, with warm fluid returning from the heat loads. Thus, the temperature control is accomplished without the need for a secondary loop, thereby obviating the need for pumps, for secondary-loop maintenance, and for wasteful over circulation of the cooling fluid. Control is achieved by a control algorithm that monitors temperature sensors upstream and downstream of the heat loads and modulates the flow to each heat load using proportional control valves whose valve openings respond to errors between the measured temperatures and a set of control objectives on the temperatures, the most important of these objectives being the maintenance of a specified, above-dew-point temperature for the coolant being supplied to the heat loads.

Embodiments of the invention include an apparatus for fluid cooling, including components such as:
a. a source of cooling fluid having a supply port at a relatively high pressure and a return port at a relatively lower pressure;
b. a heat exchanger having a cold-side intake port, a cold-side exhaust port, a hot-side intake port, a hot-side exhaust port, cold-side passageways that allow flow of fluid from the cold-side intake port to the cold-side exhaust port, and hot-side passageways that allow flow of fluid from the hot-side intake port to the hot-side exhaust port, the cold-side passageways and the hot-side passageways being arranged with good thermal contact therebetween, such that heat may readily flow from a hot fluid stream flowing in the hot-side passageways to a cold fluid stream flowing in the cold-side passageways;
c. a heat-source array comprising N heat sources, where N is an integer no smaller than one, each heat source having a heat-source intake port and a heat-source exhaust port, the N heat sources being arranged schematically in parallel;
d. a first piping means for conducting the cooling fluid from the supply port to the heat exchanger's cold-side intake port;
e. a second piping means for conducting the cooling fluid from the heat exchanger's cold-side exhaust port separately to the intake port of each heat source;
f. an N-fold array of third piping means for conducting the cooling fluid emerging from the N heat-source exhaust ports to a common heat-source return pipe,
g. a fourth piping means for conducing the cooling fluid from the common heat-source return pipe to the heat-exchanger's hot-side intake port; and
h. a fifth piping means for conducting the cooling fluid from the heat-exchanger's hot-side exhaust port to the return port,
   whereby, in the heat exchanger, the cold fluid flowing in the cold-side passageways is warmed by the hot fluid flowing in the hot-side passageways, thereby insuring that the cooling fluid supplied to the heat sources is not too cold.

Other embodiments also include an apparatus, as described above, further incorporating the following:
a. a heat-source-inlet temperature sensor that measures coolant temperature T₀ in the second piping means,
b. an N-fold array of heat-source-exhaust temperature sensors that measure, in the N-fold array of third piping means, the temperatures T₁, T₂, . . . , T_{N} of the cooling fluid emerging respectively from the N heat sources,
c. an N-fold array of control valves that respectively modulate the flows F₁, F₂, . . . , F_{N} of cooling fluid flowing to the N heat sources respectively, and
d. a controlling means that receives input signals from the heat-source-inlet temperature sensor and the heat-source-exhaust temperature sensors, and on the basis of these N+1 input signals, according to a specified control algorithm, produces N output signals, one of which is received by each of the control valves and causes its opening to be modulated, thereby controlling the flow of cooling fluid to the respective heat source.

Moreover, the embodiments may also include an apparatus, as described above, where the control algorithm is given by equations (409) through (412), a generic mathematical form made specific, for example, by equations (413) through (416), as represented in FIG. 4. Embodiments also include an apparatus as described above where the control algorithm is given by equations (709) through (712), a generic mathematical form made specific, for example, by equation (713), as shown in FIG. 7.

Additional embodiments also include an apparatus, as described above, that further comprises:
a. a supply temperature sensor that measures coolant temperature T₇ in the first piping means, and
b. a three-way valve, inserted into the first piping means, that switches, in response to a signal from the control means, between a NORMAL configuration and a BYPASS configuration, where the NORMAL configuration causes the cooling fluid to flow from the supply port to the heat-exchanger's cold-side intake port, as in Claim 2, such that T₀>T₇, whereas the BYPASS configuration causes the cooling fluid instead to flow from the supply port to the heat exchanger's cold-side exhaust port, thereby bypassing the heat exchanger, such that T₀=T₇.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 illustrates a schematic view of a prior-art water-conditioning apparatus depicting a two-loop system for controlling coolant temperature that flows to an array of heat-producing devices;

FIG. 2 illustrates a schematic view of an embodiment of this invention, showing a one-loop system for controlling coolant temperature that flows to an array of heat-producing devices;

FIG. 3 illustrates a set of mathematical equations that describe the laws of conservation of energy for the system of FIG 2, which yield expressions for the various coolant temperatures;

FIG. 4 illustrates a set of mathematical equations that describe one embodiment of a control algorithm for this invention;

FIG. 5 illustrates a graph showing the dynamic response of a prototype system of the type shown in FIG 2, using the control algorithm shown in FIG. 4;

FIG. 6 illustrates a graph showing the dynamic response of the prototype system using an improved control algorithm of the type described in FIG 7;

FIG. 7 illustrates a set of mathematical equations describing the improved control algorithm used to obtain the result shown in FIG. 6; and

FIG. 8 illustrates an alternative embodiment of the invention in comparison with that of FIG. 2, which allows the system to operate in two alternative modes, denoted respectively as NORMAL and BYPASS.

### DETAILED DESCRIPTION

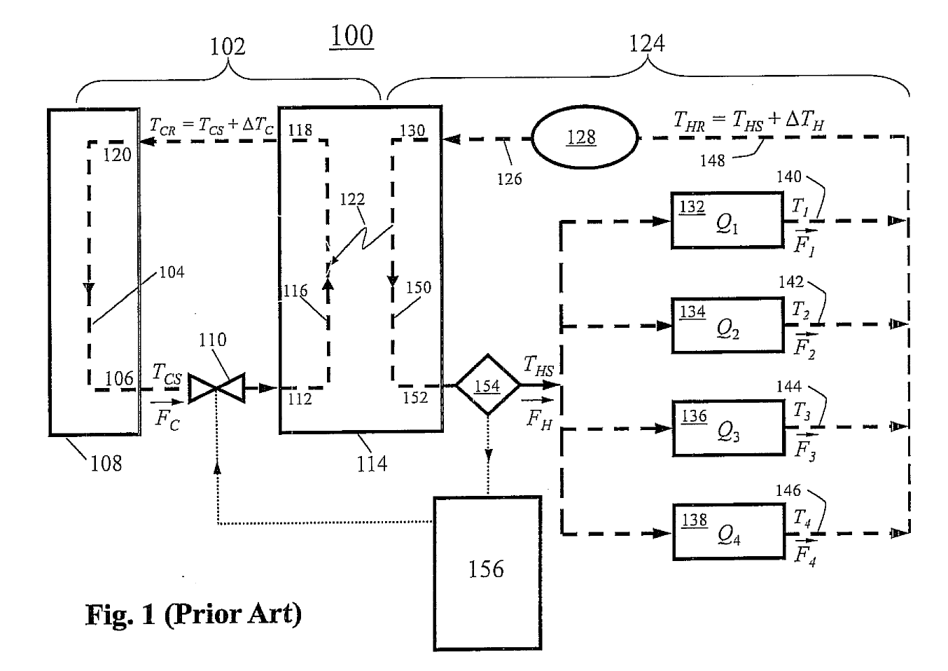

An arrangement 100 for achieving the temperature control according to the prior art is shown in FIG. 1, wherein solid shapes represent items of equipment, dashed lines represent fluid flows in pipes and other closed passageways, and dotted lines represent electrical signals. A primary loop 102 of a first fluid 104 may be described as starting at a cold port 106 of a chiller 108, which chills and circulates the first fluid 104 in the primary loop 102. From cold port 106, fluid 104 is supplied at cold-side supply temperature T_{CS} to a control valve 110, such as a globe valve, which is capable of modulating a cold-side volumetric flow rate F_{C} of the first fluid 104. Thus, flow rate F_{C} flows to the cold-side intake port 112 of a heat exchanger 114, through the heat-exchanger's cold-side passageways 116, and emerges from the heat exchanger's cold-side return port 118 at a cold-side return temperature T_{CR} that is higher than T_{CS} by & cold-side temperature difference ΔT_{C}. The first fluid 104 returns to a hot-side return port 120 of the chiller 108 at temperature T_{CR}, where it is re-cooled to temperature T_{CS} by heat exchange to an external cooling medium not shown.

Still referring to FIG. 1, the cold-side temperature difference ΔT_{C} is caused by heat exchange 122 from a secondary loop 124 of a second liquid 126. Circulation of the second liquid 126 in secondary loop 124, at a volumetric flow rate F_{H}, is driven by a pump 128, whose heat dissipation is ignored in this instance. The second fluid 126 enters a hot-side return port 130 of heat-exchanger 114 at hot-side return temperature T_{HR} that is elevated by the second fluid's absorption of heat from one or more heat-producing devices arranged in parallel, such as the four heat-producing devices 132, 134, 136, 138, which may be the same or different. The heat-producing devices 132,134,136,138 are also denoted by their respective head loads Q₁, Q₂, Q₃, and Q₄, which may also be the same or different. The parallel fluid streams 140, 142, 144, 146 emerging from the heat loads Q₁, Q₂, Q₃, and Q₄ are at temperatures T₁, T₂, T₃, and T₄ respectively, and have flow rates V₁, V₂, V₃, and V₄ respectively. Streams 140, 142, 144, and 144 mix to form a mixed stream 148 having a hot-side return temperature T_{HR}. In heat exchanger 114 the second fluid 126 flows through hot-side passageways 150 and is cooled by rejection of heat 122 to the first fluid 104, such that the second fluid 126 emerges from a hot-side supply port 152 of heat exchanger 114 at hot-side supply temperature T_{HS}, which is lower than T_{HR} by a hot-side temperature difference ΔT_{H}.

In FIG. 1, the aforesaid objective of controlling the temperature T_{HS} of the fluid flowing to the heat-producing devices 132, 134, 136, 138 is accomplished by periodically measuring the hot-side supply temperature T_{HS} using a temperature sensor 154, and supplying this information electronically to a controller 156, which compares the measured temperature T_{HS} to the desired temperature T_{HS}_{_{—}}_{SET-POINT}, thereby determining an error

e=T_{HS}−T_{HS}_{_{—}}_{SET-POINT}.

The controller 156 is configured in such a way that whenever e<0 (i.e. whenever T_{HS} is too cold), the controller sends a command to the control valve 110, causing it to close slightly, thereby decreasing flow-rate F_{C} of the first fluid 104 in primary loop 102, and thus decreasing the rate of heat transfer 122, which leads to increased T_{HS}. Thus, the error e is driven toward zero. Conversely, the controller 156 is also configured in such a way that whenever e>0 (i.e. whenever T_{HS} is too hot), the controller sends a command to the control valve 110 causing it to open slightly, thereby increasing flow-rate F_{C} of first fluid 104 in primary loop 102, and thus increasing the rate of heat transfer 122, which leads to a decreased T_{HS}. Thus, the error e is again driven toward zero.

Deficiencies of the prior-art system of FIG. 1 are caused by the existence of the secondary loop 124. First, the secondary loop 124 requires its own pump 128 to circulate the second fluid 126. Pumps are failure prone and thus require redundancy, so a robust system must have at least two. Moreover, pumps are often quite large for systems with large heat loads Qᵢ, and because in many applications they are, like the heat exchanger 114, preferably local to the heat loads Q₁, Q₂, Q₃, Q₄, their large size occupies valuable space that could otherwise be occupied by a greater number of useful heat-producing devices such as 132, 134, 136, 138.

Another difficulty of the prior-art system 100 is that the secondary loop must be separately filled and maintained. Filling must be done carefully with coolant that is clean and chemically suitable to minimize unwanted effects such as corrosion, fouling, and microbiological growth. This is particularly true for water, the most common liquid coolant. The host of problems that can occur are discussed in books such as Cooling Water Treatment: Principles and Practice, by Colin Frayne, Chemical Publishing Co., NY, ISBN 0-8206-0370-8, which is incorporated herein in its entirety by reference. Maintenance of the secondary loop also includes the need for an expansion tank to accommodate thermal expansion of the coolant, as well as the need for a “make-up” facility to replenish coolant volume that is inevitably lost, for example, when quick connects are repeatedly connected and disconnected.

Yet another shortcoming of the prior-art system 100 is that, regardless of the actual total power dissipation Q=Q₁+Q₂+Q₃+Q₄, the pump 128 continuously circulates the maximal amount of cooling fluid required for maximum Q, despite the fact that, in real systems, Q may vary drastically, and may rarely reach its maximum value. Thus the prior-art system 100 wastes pump power.

Much practical convenience and economic benefit accrues, therefore, if temperature control of liquid coolant can be accomplished with the primary loop 102 only, without the need for the secondary loop 124. If the first fluid 104 that cools the primary loop 102 could be used directly to cool the heat-producing devices 132, 134, 136, 138, then no pumps, chemical treatment, expansion control, or make-up provision would be required, because these facilities, like the chiller 108, already exist for the primary-loop coolant 104, which is typically maintained at the building level by a staff of water-treatment experts.

In the various embodiments of the disclosure, elements or components which are similar or identical to each other are designated with the same reference numerals, as applicable.

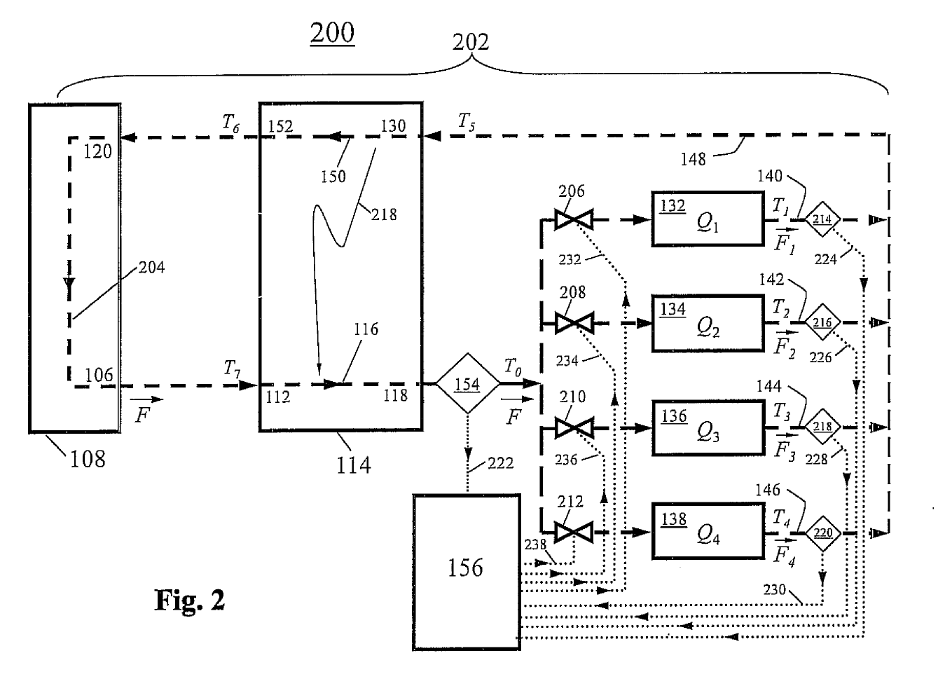

FIG. 2 shows an illustrative embodiment of a water-conditioning apparatus 200 according to the present invention, using the same reference numerals for like elements as the prior art apparatus 100 shown in FIG. 1. As in FIG. 1, the solid rectangles in FIG. 2 represent pieces of equipment, and the dotted lines represent electrical signals. However, as distinct from FIG. 1, the dashed lines in FIG. 2 represent the flow of a single cooling fluid 204 in an integrated loop 202, rather than representing, as in FIG. 1, two fluids in two separate loops.

The integrated fluid loop 202 may be described starting at the cold-side intake port 112 of heat exchanger 114, where the cooling fluid 204 enters from the cold port 106 of chiller 108 at temperature T₇ and flows through the cold-side passageways 116 of the heat exchanger 114 to the cold-side exhaust port 118, where it exits at temperature T₀. The fluid's temperature T₀ is measured by the cold-side temperature sensor 154, after which the fluid loop 202 divides into an arbitrary number N of parallel segments. For illustrative purposes, N=4 in FIG. 2, but in general N may be any positive integer. Each segment comprises a control valve, a heat-producing device, and a hot-side temperature sensor. For example, the uppermost segment shown on FIG. 2 comprises a control valve 206, the heat-producing device 132, and a hot-side temperature sensor 214. Likewise, the other three segments shown on FIG. 2 comprise control valves 208, 210, 212, heat-producing devices 134, 136, 138, and hot-side temperature sensors 216, 218, 220, respectively.

In general, the term “heat-producing device” includes not only objects that directly generate heat, but also objects, such as heat sinks and heat-exchanger fins, that may have absorbed heat from other objects. Thus, for example, the current invention may be used in conjunction with an invention such as that described in the previously mentioned co-pending application U.S. Ser. No. 11/939,165 (“Water-Assisted Air Cooling for a Row of Cabinets”), where the “heat-producing devices” are the fins of air-to-liquid heat exchangers, and the “cooling fluid” 204 is the liquid flowing in the heat exchangers.

The N parallel segments of the fluid loop 202 recombine after the temperature sensors 214, 216, 218, 220, forming the mixed stream 148, at temperature T₅, that flows to the hot-side intake port 130 of heat exchanger 114, thence through the heat-exchanger's hot-side passageways 150, and thence to the heat-exchanger's hot-side exhaust port 152, where the fluid exits the heat exchanger 114 at temperature T₆. The fluid 104 in fluid loop 202 then returns to the hot port 120 of chiller 108, where it is re-cooled to temperature T₇ by heat exchange to an external cooling medium, not shown.

The essence of the invention resides in the concept that the cold fluid delivered by the chiller 108, at temperature T₇, may be warmed to the above-dew-point temperature T₀ by the hot fluid at temperature T₅ that returns from the heat-producing devices 132, 134, 136, 138. This warming does not cost any energy, because it is accomplished by the waste heat of the apparatus 200. The hot fluid stream 148 enters the hot-side intake port 130 of heat exchanger 114 at an elevated temperature T₅. As it flows through the hot-side passageways 150 of the heat exchanger, the hot fluid transfers heat 218 to the cold fluid flowing through cold-side passageways 116. Consequently, the hot fluid exits the hot-side exhaust port 152 at a reduced temperature T₆.

The feasibility and capabilities of this system are best demonstrated analytically. Let ρ be the density of the fluid and c be the specific heat of the fluid. The total volumetric flow rate F of fluid 104 in the loop 202 is

FηF₁+F₂+F₃+F₄, (1)

where F₁, F₂, F₃, F₄ are volumetric flow rates in the four parallel fluid streams 140, 142, 144, 146. The total heat dissipation Q of the four heat loads is

QηQ₁+Q₂+Q₃+Q₄. (2)

where Q₁, Q₂, Q₃, and Q₄, having SI units of watts, are heat dissipations in the four heat-producing devices 132, 134, 136, 138.

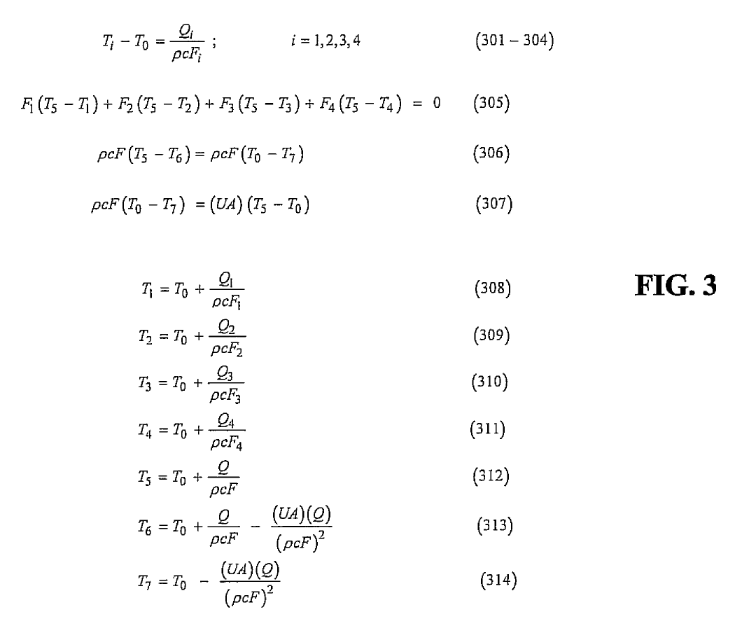

Referring to FIG. 3, steady-state energy conservation in the heat-producing devices 132, 134, 136, 138 yields equations (301) through (304) respectively. Steady-state energy conservation is involved in mixing the four fluid streams 140, 142, 144, 146 into the combined stream 148 yields equation (305). Steady-state energy conservation in the heat exchanger 114 yields equation (306). Equation (307) is a performance statement for the heat exchanger 114, where (UA), a property of the heat exchanger and the fluids flowing through it, is typically quoted by the heat-exchanger manufacturer as a function of flow rate F. The SI units of (UA) are watts per degree C.

Still referring to FIG. 3, and assuming that T₀, the Fᵢ and the Qᵢ are given, equations (301) through (307) are seven equations in the seven unknowns T₁, T₂, T₃, T₄, T₅, T₆, and T₇. The solutions for T₁, T₂, T₃, T₄, which proceed directly from equations (301) through (304), are given in equations (308) through (311). Substituting (308) through (311) into (305) yields equation (312). Substituting (312) into (307) yields (314). Substituting (312) and (314) into (306) yields (313). Thus, equations (308) through (314) provide the complete solution for all the fluid temperatures in the apparatus (200).

Reverting to the analysis of FIG. 2, it is noted that in general, the apparatus 200 may comprise an arbitrary integer number N of parallel segments, each segment comprising a control valve such as 206, a heat-producing device such as 132, and a hot-side temperature sensor such as 214. Although the equations on FIG. 3, and in subsequent analysis herein, show explicitly the mathematical relationships for N=4, the extension to arbitrary N is straightforward, and obvious to anyone skilled in the art of mathematics.

Equation (314) quantifies the temperature rise T₀−T₇ that may be obtained from a heat exchanger of a given capacity (UA). For example, if the fluid is water (ρ=1000 kg/m³, c=4180 J/kg-° C.), and if T₀−T₇ is expressed in ° C., (UA) in kW/° C., and Q in kW, then equation (314) becomes

$${T}_{0} - {T}_{7} [ ° C . ] = 206.04 \frac{( UA [ \frac{kW}{° C .} ] ) ( Q [ kW ] )}{{( F [ \frac{liter}{min} ] )}^{2}} . ( water ) \qquad ( 3 )$$

As a specific example, if the maximum flow rate through the system (usually limited by pipe size or available line pressure) is F=378.5 liter/min, if the value of UA at this flow rate is UA=43.5 kW, and if the heat load is Q=160 kW, then T₀−T₇=10° C. This is an appropriate value, because chilled-water systems often supply water at about 8° C., whereas to avoid condensation on the Class I equipment (as explained earlier), T₀ should be about 18° C., i.e. about 10° C. warmer than T₇.

In typical systems, the total power Q may vary. In such cases, it is interesting to know how total flow rate F must theoretically vary to achieve a constant value of T₀−T₇. This question is complicated by the fact that (UA) for real heat exchangers is often not a simple function of F. However, the approximation

UA=κF^{m}, where 0<m<1 (4)

is often reasonable, with a typical value of m being m=½, Equation (4) provides for an insight, because equation (314) may then be written as

$$F = {\{ ( \frac{κ}{{( ρ c )}^{2}} ) ( \frac{Q}{{T}_{0} - {T}_{7}} ) \}}^{\frac{1}{2 - m}} . \qquad ( 5 )$$

In other words, under assumption (4), the required total flow rate F varies directly as the

$$\frac{1}{2 - m}$$

power of the total heat load Q, and inversely as the

$$\frac{1}{2 - m}$$

power of the required temperature difference T₀−T₇. Thus, under simplifying assumption (4), T₀−T₇ will remain constant if

$$F ∝ {Q}^{\frac{1}{2 - m}} . \qquad ( 6 )$$

Specifically, to keep T₀−T₇ constant under varying thermal load Q, the total flow rate F should vary as follows:

if m=0, F∝Q^{1/2};

if m=½×, F∝Q^{2/3}; (7)

if m=1, F∝Q.

Another temperature difference of interest is T₆−T₇, because typical chillers demand

T₆−T₇<ΔT₆₇_{_{—}}_{MAX}, (8)

where, for many chillers, ΔT₆₇_{_{−}}_{MAX}=6° C. Subtracting equation (314) from equation (313) yields

$${T}_{6} - {T}_{7} = \frac{Q}{ρ cF} . \qquad ( 9 )$$

Substituting (5) into (9) yields

$${T}_{6} - {T}_{7} = {\{ \frac{{( ρ c )}^{m} {Q}^{1 - m} ( {T}_{0} - {T}_{7} )}{κ} \}}^{\frac{1}{2 - m}} \qquad ( 10 )$$

Therefore, if (6) is followed to achieve constant T₀−T₇, then, according to (10),

T₆−T₇∝Q^{(1-m)/(2-m)}. (11)

Specifically,

if m=0, T₆−T₇∝Q^{1/2};

if m=½, T₆−T₇∝Q^{1/3}; (12)

if m=1, T₆−T₇ is independent of Q.

It is clear from equation (3) that, in general, the heat exchanger 114 must be sized correctly for the intended application. That is, equation (314) should be used to select the value of UA that is large enough to produce the required temperature rise T₀−T₇ for the maximum expected heat load Q, within the constraint of available flow rate F. For smaller Q, F should simply be reduced, according to (6), to hold T₀−T₇ constant, a strategy that causes T₆−T₇ to decrease, according to (11), thus not violating the requirement (8). In other words, the invention has been shown theoretically to be viable: it satisfies its primary goal of allowing control of T₀−T₇ despite varying load Q, and it also satisfies, under varying thermal load, the restriction (8) common to many commercial chillers.

In a real system, of course, it is impractical to set flow rate F in an open-loop fashion relying on theoretical laws such as (4). Instead, referring again to FIG. 2, closed-loop feedback must be employed to insure the primary objective, i.e., that T₀ maintain a set-point temperature that is slightly above the worst-case dew-point temperature of the environment in which apparatus 200 must operate. Feedback must also insure that, by means of the control valves 206, 208, 210, 212, the flow rates F₁, F₂, F₃, F₄ through the several heat-producing devices 132, 134, 136, 138 are balanced in response to the varying heat loads Q₁, Q₂, Q₃, Q₄. A closed-loop feedback scheme that achieves these objectives will now be described. Although the scheme is described for N=4, it may be easily generalized to an arbitrary value of N.

Referring to FIG. 2, temperatures T₀, T₁, T₂, T₃, and T₄ are measured by temperature sensors 154, 214, 216, 218, and 220, respectively, and these five measurements are reported periodically to the electronic controller 156 via electrical signals 222, 224, 226, 228, and 230, respectively. The ideal relationships among the temperatures are:

T₀=T₀_{_{—}}_{SetPoint} (13.1)

T₂=T₁ (13.2)

T₃=T₁ (13.3)

T₄=T₁ (13.4)

Equation (13.1) sets forth that T₀ is ideally equal to a set-point temperature T₀_{_{—}}_{SetPoint}, which is chosen to be slightly above the worst-case dew-point temperature of the environment in which the apparatus 200 is operating. As explained hereinabove, a typical value for an ASHRAE Class 1 data-processing environment is T₀_{_{—}}_{SetPoint}=18° C. Equations (13.2), (13.3), (13.4) specify that the temperatures T₁, T₂, T₃, T₄ downstream of the heat-producing devices 132, 134, 146, 138 are all ideally equal, which implies that the flow rates F₁, F₂, F₃, and F₄ are ideally balanced in proportion to the heat loads Q₁, Q₂, Q₃, and Q₄.

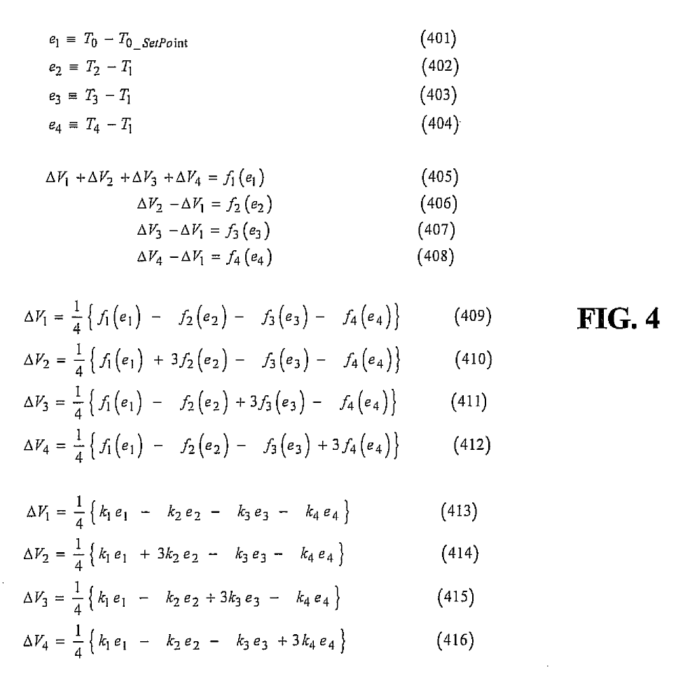

Referring to FIG. 2 and FIG. 4, each time the temperature measurements carried by signals 222, 224, 226, 228, 230 are reported to the electronic controller 156, it computes four errors, denoted e₁, e₂, e₃, e₄, which are defined in FIG. 4 by equations (401) through (404), respectively. To drive these errors toward zero, the electronic controller 156 must send to the four control valves 206, 208, 210, 212 electronic signals 232, 234, 236, 238, respectively, which may, for example, be voltages V₁, V₂, V₃, V₄, respectively. For typical systems, each of these voltages may vary continuously from 2 volts to 10 volts, where a 2 volt signal causes the respective valve to fully close, whereas a 10 volt signal causes the valve to fully open, and intermediate voltages cause the valve to assume a partially open position that is a continuous function of the voltage.

Rather than specifying values of the voltages V₁, V₂, V₃, V₄ per se, it is preferable that the controller specify voltages corrections ΔV₁, ΔV₂, ΔV₃, ΔV₄, respectively, which are functions of the errors. At each iteration of the control loop, which is executed incessantly by the electronic controller 156, typically at the rate of several executions per second, the changes ΔV₁, ΔV₂, ΔV₃, ΔV₄ are applied to the voltages V₁, V₂, V₃, V₄. That is, at each iteration of the control loop, the following adjustments are made:

V₁←Vᵢ+ΔVᵢ; i=1, 2, 3, 4. (14)

Suitable relationships between the voltage corrections ΔV₁, ΔV₂, ΔV₃, ΔV₄ and the measured errors e₁, e₂, e₃, e₄ will now be established by heuristic representatives.

Because overall flow rate F and temperature T₀ are inversely related, according to a relation like (5), the desired change to F should have the same sign as the measured error e₁. That is, if fluid temperature T₀ is too low (e₁<0), the overall flow rate F should decrease; if T₀ is too high (e₁>0), the overall flow rate F should increase. Because F responds to the sum of the voltage changes, ΔV₁+ΔV₂+ΔV₃+ΔV₄, it follows that this sum should have the same sign as the measured error e₁. Thus equation (405) is heuristically inferred, where ƒ₁ is a positive function of e₁, but is otherwise arbitrary.

If the measured temperature T₂ of cooling fluid flowing through heat load Q₂ is larger than the temperature T₁ of cooling fluid flowing through heat load Q₁; that is, if e₂>0—then the flow rate F₂ should be increased relative to F₁. Consequently, because Fᵢ is a monotonically increasing function of Vᵢ, ΔV₂−ΔV₁ should have the same sign as e₂. This leads to equation (406), where ƒ₂ is a positive function of e₂, but is otherwise arbitrary. Similar representations lead to equations (407) and (408).

Equations (405) through (408) comprise a set of four linear algebraic equations in the four unknowns ΔV₁, ΔV₂, ΔV₃, ΔV₄. Substituting equations (406) through (408) into (405) yields (409). Substituting (409) into (416), (407), and (408) yields (410), (411), and (412) respectively.

The simplest form of the functions ƒᵢ(eᵢ) is

ƒᵢ(eᵢ)=kᵢeᵢ; i=1, 2, 3, 4, (15)

where the symbols kᵢ represent constants. If the special form (15) is adopted, then equations (409) to (412) reduce to equations (410) to (413) respectively.

The current invention has been reduced to practice. It is embodied in a prototype water-cooled system designed for maximum heat loads of

(Q₁)ₘₐₓ=(Q₂)ₘₐₓ=(Q₃)ₘₐₓ=(Q₄)ₘₐₓ=40 kW, (16)

whence, according to definition (2),

QηQ₁+Q₂+Q₃+Q₄=160 kW. (17)

In this system, using the nomenclature of FIG. 2, the chiller 108 supplies cooling water at

T₇λ8° C., (18)

and accommodates a differential temperature of

T₆−T₇=T₁−T₀[6° C.; (i=1, 2, 3, 4). (19)

With the values of fluid properties for water (ρ=1000 kg/m³, c=4180 J/kg-° C.), equation (9) and (19) imply a maximum total flow rate of

$$\begin{matrix}\begin{matrix}F = \frac{Q}{ρ c ( {T}_{6} - {T}_{7} )} \\ = \frac{160 , 000 W}{( 1000 \frac{kg}{{m}^{3}} ) ( 4180 \frac{J}{kg - ° C .} ) ( 6 ° C . )} \\ = 0.006380 \frac{{m}^{3}}{s} \\ = 101 gallons \text{/} minute .\end{matrix} & ( 20 )\end{matrix}$$

The performance parameter UA of the heat exchanger 114 is sized using equation (314):

$$\begin{matrix}\begin{matrix}UA = \frac{{( ρ cF )}^{2} ( {T}_{0} - {T}_{7} )}{Q} \\ = \frac{{\{ ( 1000 \frac{kg}{{m}^{3}} ) ( 4180 \frac{J}{kg - ° C .} ) ( 0.00638 \frac{{m}^{3}}{s} ) \}}^{2} ( 18 ° C . - 8 ° C . )}{160000 W} \\ = 44.45 kW \text{/} ° C .\end{matrix} & ( 21 )\end{matrix}$$

To supply this performance, a brazed-plate heat exchanger is used: model WP8-90 manufactured by WTT America Corporation. The control valves 206, 208, 210, 212 used to handle the maximum branch flow rate of (Fᵢ)ₘₐₓ=25 gallon/minute are globe valves (model G232+NV24−MFT US+NC+V−100001) manufactured by Belimo Corporation. Each temperature sensor assembly, 154, 214, 216, 218, 220, comprises parts manufactured by Minco Corporation, including an RTD sensor (model S460PD58Y2), a thermowell (model TW488U35), a connection head (model CH360P3T0), and a transmitter (model TT111PD1KP). The electronic controller 156 comprises parts manufactured by Schneider Electric Corporation, including an analog I/O base (model 170ANR12090), a Modbus adapter (model 172JNN21032), a processor adapter (model 171CCC98030), and a touch-screen display (model XBTGT2110). The control algorithm expressed by equations (413) to (416) is implemented in software running on the processor within the processor adapter. The values of parameters (e.g. k₁, . . . , k₄) are set, and the status of variables (e.g. temperatures T₀, T₁, T₂, T₃, T₄) are monitored, via the touch-screen display.

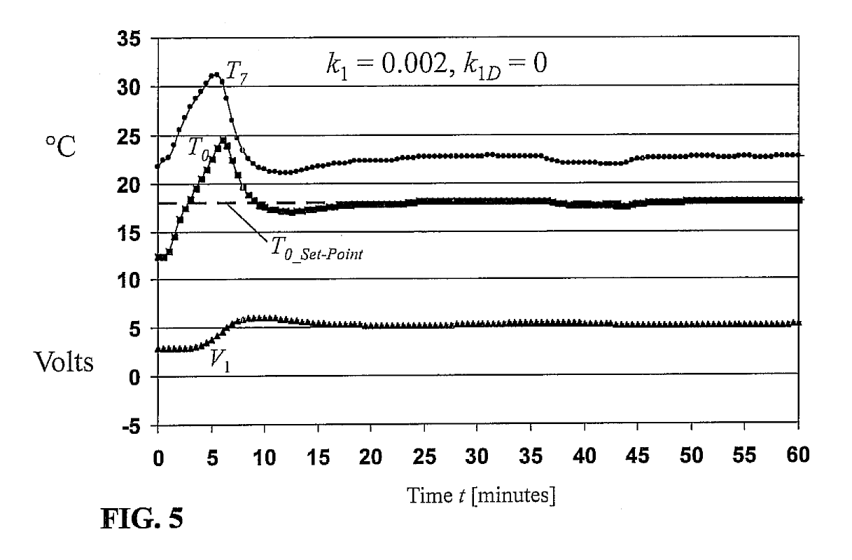

FIG. 5 shows the results of a preliminary test of the prototype embodiment in which only one thermal load, Q₁, is non-zero. For this simple case, the general control algorithm described by equations (413) to (416) reduces to the following single equation:

$$Δ {V}_{1} = \frac{1}{4} {k}_{1} {e}_{1} , \qquad ( 22 )$$

where, as given by definition (401),

e₁≡T₀−T₀_{_{—}}_{Set-Point}. (23)

For the data shown on FIG 5, k₁=0.002. The control loop that implements equation (21) is executed about five times per second, whereas the data points shown on FIG. 5 are taken at 30 second intervals. At time t=0, the system is started cold, with Q₁=0. Thereafter, the condition Q₁=36.2 kW is suddenly applied. Consequently, the case shown in FIG. 5 is essentially a worst-case thermal shock. Nevertheless, the system stabilizes to the desired result, T₀=T₀_{_{—}}_{Set-Point}, about 17 minutes.

To reduce the overshoot in temperatures T₀ and T₇ shown in FIG. 5 between tλ3 minutes and tλ9 minutes, the control algorithm (21) may be modified. Recalling equation (22) and defining a difference error e_{1D} as follows,

e₁_{_{—}}_{NEW}≡e₁ measured during current iteration of control loop

e₁_{_{—}}_{OLD}≡e₁ measured during last iteration of control loop (24)

e_{1D}≡e₁_{_{—}}_{NEW}−e₁_{_{—}}_{OLD},

the following improved control algorithm is defined for the simple case where only one heat load, Q₁, is non-zero:

$$Δ {V}_{1} = \frac{1}{4} \{ {k}_{1} {e}_{1} + {k}_{1 D} {e}_{1 D} \} . \qquad ( 25 )$$

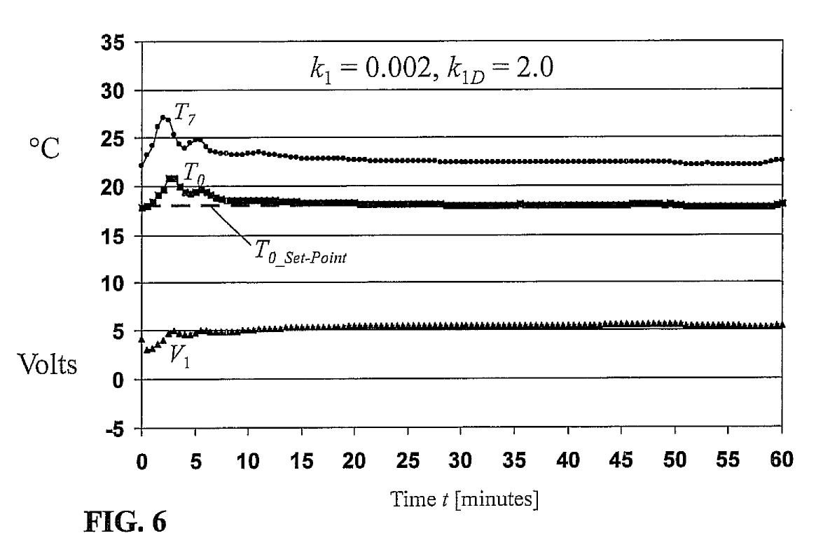

The second term in equation (25) causes V₁ to increase faster (i.e. causes control valve 206 to open faster, causing a faster increase in flow rate F) when e₁—the discrepancy between T₀ and T₀_{_{—}}_{Set-Point}—is growing rapidly, as it is on FIG. 5 in the interval of between tλ1 minute and tλ6 minutes. Increasing F faster under these circumstances is beneficial because it tends to forestall the unwanted increase in T₀, inasmuch as the last term on the right-hand side of equation (314) is made smaller by larger F. Experimental results of the improved algorithm (25) are shown in FIG. 6, where k₁=0.002 and k_{1D}=2.0. FIG. 5 and FIG. 6 should be compared: in the interval of between tλ3 minutes and tλ9 minutes, FIG. 6 (for which k_{1D}=2.0) has much smaller overshoot than FIG. 5 (for which k_{1D}=0), thereby proving the effectiveness of the improved control algorithm (25) vis-à-vis the simpler control algorithm (22).

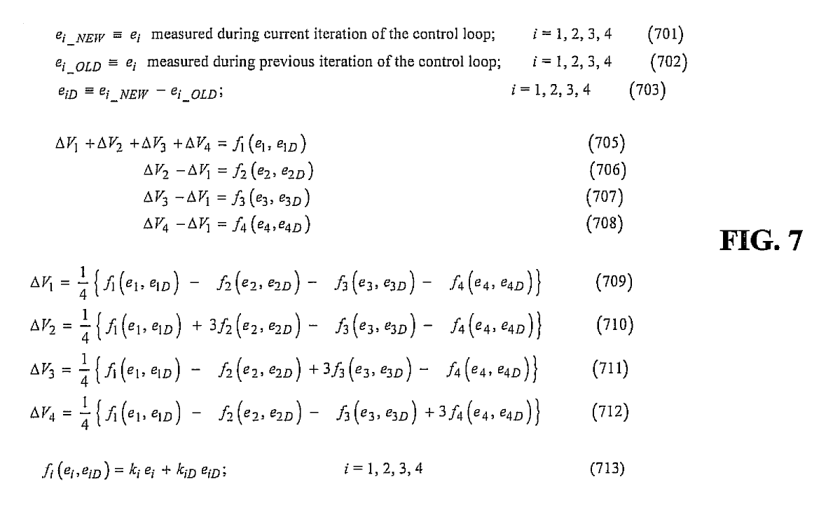

Generalizing the improved control algorithm (24) to the general case, in which all the heat loads Qᵢ are non-zero (i=1, 2, 3, 4), leads to the equations shown on FIG. 7, for which definitions (401) through (404) on FIG. 4 still apply. Equations (701) through (703) are straightforward generalizations of equation (23). Equations (705) through (712) are straightforward analogs of equations (405) through (412), respectively, and are derived as described previously in connection with FIG. 4. The symbols ƒᵢ(eᵢ, e_{iD}) prescribe general functions of eᵢ and e_{1D}; a specific example of such functions, analogous to that used in equation (25) above, is given by equation (713), where kᵢ and k_{iD} are constants.

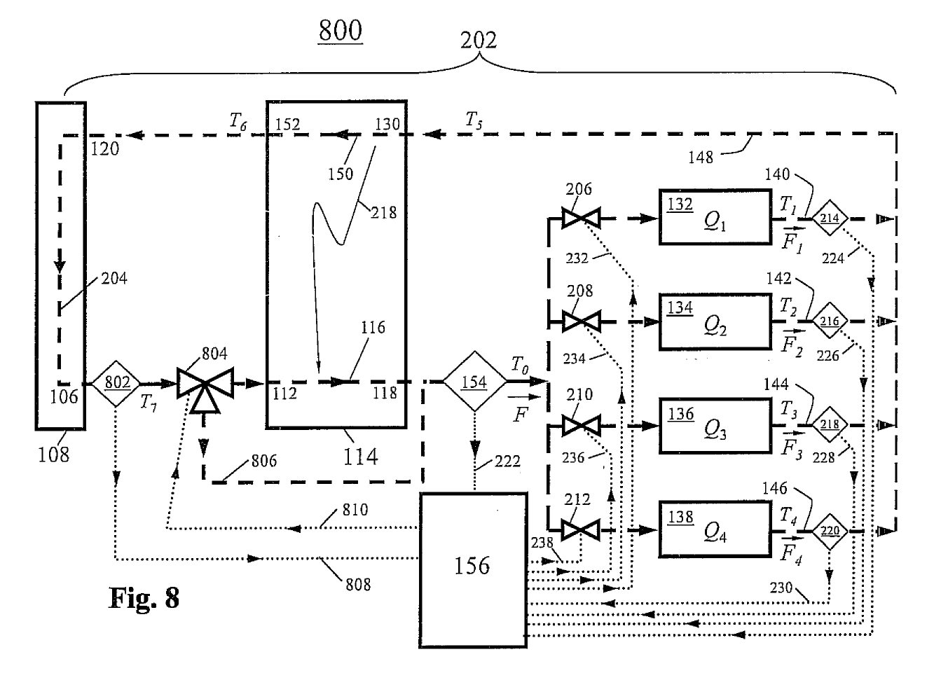

Referring to FIG. 8, a revised embodiment 800 of the invention is appropriate for applications in which the temperature T₇ of cooling fluid 204 supplied by the chiller 108 is sometimes or always above the dew-point temperature T_{DP} of ambient air rather than, as previously assumed, always below T_{DP}. In such applications, the temperature difference implied by equation (314) for the original embodiment as shown in FIG. 2,

$${T}_{0} - {T}_{7} = \frac{( UA ) ( Q )}{{( ρ cF )}^{2}} , \qquad ( 26 )$$

is typically undesirable, because, whenever T₇ is already above the dew-point temperature, this excess temperature has no purpose—all temperatures in the heat-producing devices 132, 134, 136, 138 are simply raised, unnecessarily and with possibly deleterious effects, by the amount T₀−T₇. To avoid this problem, embodiment 800 comprises, in addition to the equipment described in embodiment 200, a temperature sensor 802 that measures T₇, and also comprises a three-way control valve 804, which can assume two positions: first, a “normal position”, denoted NORMAL, in which the coolant 104 flows to port 112 of the heat exchanger 114, as in embodiment 200; and second, a “bypass position”, denoted BYPASS, in which the coolant flows instead along a bypass path 806 that bypasses the heat exchanger, such that T₀=T₇.

Also referring to FIG. 8, in order to allow automatic switching between the two positions NORMAL and BYPASS of the three-way control valve 804, embodiment 800 specifies that the measurement of temperature T₇ obtained by temperature sensor 802 be communicated via an electrical signal 808 to the electronic controller 156 at each iteration of the control algorithm being executed therein. At each iteration of the control algorithm, the electronic controller 156, via an electrical signal 810, may direct the three-way valve to switch from its current position, denoted CURRENT, which is either NORMAL or BYPASS, to a new position, denoted NEW, which is also either NORMAL or BYPASS. The switching rule carried out in software in the electronic controller is as follows:

if (CURRENT=NORMAL AND T₇>T₀_{_{—}}_{Set-Point}+ΔT_{HYSTERESIS}), NEW=BYPASS;

else if (CURRENT=BYPASS AND T₇<T₀_{_{—}}_{Set-Point}−ΔT_{HYSTERESIS}), NEW=NORMAL;

else NEW=CURRENT;

The parameter ΔT_{HYSTERESIS} guarantees that the valve will not unnecessarily oscillate between NORMAL and BYPASS.

Moreover, in FIG. 8, whenever the three-way control valve 804 is in the NORMAL position, the software in electronic controller 156 executes the NORMAL feedback algorithm previously described generically by equations (709) through (712), and made specific by equation (713). However, whenever the three-way control valve 804 is in the BYPASS position, the software in electronic controller 156 instead executes a BYPASS feedback algorithm that is much simpler than the NORMAL feedback algorithm, because in BYPASS mode T₀ is fixed at the temperature T₇ of the input stream. Consequently, there are only four temperatures (T₁, T₂, T₃, T₄) to control with the four control valves 206, 208, 210, 212 rather than five temperatures (T₀, T₁, T₂, T₃, T₄). Thus temperatures T₁, T₂, T₃, T₄ are independently controllable with the control valves 206, 208, 210, 212, respectively.

A suitable control algorithm for BYPASS mode arises from the observation that, in BYPASS mode, no heat exchange occurs in heat exchanger 114, so T₀=T₇ and T₅=T₆, whence

T₆−T₇=T₅−T₀. (27)

Because T₅ is a flow-rate-weighted average of T₁, T₂, T₃, and T₄, it follows that controlling Tᵢ−T₀ (i=1, 2, 3, 4) is tantamount to controlling T₅−T₀, which is, according to equation (23), tantamount to controlling T₆−T₇. The latter is useful because the external equipment providing the coolant often imposes a requirement such as equation (8), T₆−T₇≦ΔT₆₇, where ΔT₆₇ is specified. Consequently, in BYPASS mode, there is sought to drive the errors

δᵢ≡(Tᵢ−T₀)−ΔT₆₇; i=1, 2, 3, 4 (28)

to zero, because then ΔT₆₇=Tᵢ−T₀=T₅−T₀=T₆−T₇, which satisfies equation (8).

The appropriate control-system response to the errors δᵢ is to increment the control voltages V₁, V₂, V₃, V₄ that drive the control valves 206, 208, 210, 212 by increments

ΔVᵢ=cᵢδᵢ; i=1, 2, 3, 4; (29)

where the cᵢ are suitable positive constants. The cᵢ are positive because δᵢ>0 implies too large a value of Tᵢ, which implies too small a flow rate Fᵢ, which implies too low a voltage Vᵢ, which implies that ΔVᵢ should be positive. For BYPASS mode, equations (29) replace the control equations (413) through (416) used in NORMAL mode.

By analogy to the improved NORMAL-mode control algorithm described on FIG. 7, an improved control system for BYPASS mode, replacing (26), is

ΔVᵢ=cᵢδᵢ+c_{iD}δ_{iD}; i=1, 2, 3, 4; (31)

where

δ_{iD}=δᵢ_{_{—}}_{NEW}−δᵢ_{_{—}}_{OLD}; i=1, 2, 3, 4

δᵢ_{_{—}}_{NEW}≡δᵢ measured on current iteration of control loop

δᵢ_{_{—}}_{OLD}≡δᵢ measured on previous iteration of control loop

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. An apparatus for the temperature control of a cooling fluid, said apparatus comprising:
a. a source for supplying said cooling fluid having a supply port under a high pressure and a return port under a lower pressure;
b. a heat exchanger having a cold-side intake port, a cold-side exhaust port, a hot-side intake port, a hot-side exhaust port, cold-side passageways for allowing a flow of said cooling fluid from the cold-side intake port to the cold-side exhaust port, and hot-side passageways for allowing a flow of said cooling fluid from the hot-side intake port to the hot-side exhaust port, the cold-side passageways and the hot-side passageways being arranged to facilitate a good thermal contact therebetween, such that heat is readily flowable from a hot cooling fluid stream flowing in the hot-side passageways to a cold cooling fluid stream flowing in the cold-side passageways;
c. a heat-source array comprising N heat sources, where N is an integer no smaller than one, each said heat source having a heat-source intake port and a heat-source exhaust port, the N heat sources being arranged in parallel;
d. a first piping structure for conducting the cooling fluid from the supply port to the cold-side intake port of said heat exchanger;
e. a second piping structure for conducting the cooling fluid from the cold-side exhaust of the heat exchanger port separately to the intake port of each said heat source;
f. an N-fold array of third piping structures for conducting the cooling fluid emerging from the N heat-source exhaust ports to a common heat-source return pipe,
g. a fourth piping structure for conducting the cooling fluid from the common heat-source return pipe to the hot-side intake port of the heat exchanger; and
h. a fifth piping structure for conducting the cooling fluid from the hot-side exhaust port of the heat exchanger to the return port,
whereby, in the heat exchanger, the cold fluid flowing in the cold-side passageways is warmed by the hot fluid flowing in the hot-side passageways, thereby insuring that the cooling fluid supplied to the heat sources is not too cold.

2. An apparatus as claimed in claim 1, wherein a heat-source-inlet temperature sensor measures the cooling fluid temperature T₀ in the second piping structure.

3. An apparatus as claimed in claim 2, wherein an N-fold array of heat-source-exhaust temperature sensors measure, in the N-fold array of third piping structure, the temperatures T₁, T₂, . . . T_{N} of the cooling fluid emerging respectively from the N heat sources.

4. An apparatus as claimed in claim 3, wherein an N-fold array of control valves respectively modulate the flows F₁, F₂, . . . , F_{N} of cooling fluid flowing to the respective N heat sources.

5. An apparatus as claimed in claim 4, wherein a controlling means receives input signals from the heat-source-inlet temperature sensor and the heat-source-exhaust temperature sensors, and on the basis of these N+1 input signals, according to a specified control algorithm, produces N output signals, one of which is received by each of the control valves and causes an opening thereof to be modulated, thereby controlling the flow of cooling fluid to the respective heat source.

6. An apparatus as claimed in claim 1, wherein a supply temperature sensor measures coolant temperature T₇ in the first piping structure, wherein is located a three-way valve that switches, in response to a signal from the control means, between a NORMAL configuration and a BYPASS configuration, where the NORMAL configuration causes the cooling fluid to flow from the supply port to the cold-side intake port of the heat exchanger, such that in the NORMAL configuration the temperature T₀ is greater than the temperature T₇, whereas the BYPASS configuration causes the cooling fluid instead to flow from the supply port to the cold-side exhaust port of the heat exchanger, such that in the BYPASS configuration the temperature T₀ is equal to the temperature T₇.

7. An apparatus as claimed in claim 1, wherein said cooling fluid is pre-treated in a single-loop system for controlling the temperature of the cooling fluid within specified limits.

8. A method for controlling the temperature of a cooling fluid, said method comprising:
a. providing a source for supplying said cooling fluid having a supply port under a high pressure and a return port under a lower pressure;
b. providing a heat exchanger having a cold-side intake port, a cold-side exhaust port, a hot-side intake port, a hot-side exhaust port, cold-side passageways for to facilitate flow of said cooling fluid from the cold-side intake port to the cold-side exhaust port, and hot-side passageways for allowing a flow of said cooling fluid from the hot-side intake port to the hot-side exhaust port, the cold-side passageways and the hot-side passageways being arranged to facilitate a good thermal contact therebetween, such that heat is readily flowable from a hot cooling fluid stream flowing in the hot-side passageways to a cold cooling fluid stream flowing in the cold-side passageways;
c. providing a heat-source array comprising N heat sources, where N is an integer no smaller titan one, each said heat source having a heat-source intake port and a heat-source exhaust port, and arranging the N heat sources in parallel;
d. including a first piping structure which conducts the cooling fluid from the supply port to the cold-side intake port of said heat exchanger;
e. having a second piping structure which conducts the cooling fluid from the cold-side exhaust of the heat exchanger port separately to the intake port of each said heat source;
f. providing an N-fold array of a third piping structure for conducting the cooling fluid emerging from the N heat-source exhaust ports to a common heat-source return pipe,
g. having a fourth piping structure which conducts the cooling fluid from the common heat-source return pipe to the hot-side intake port of the heat exchanger; and
h. providing a fifth piping structure which conducts the cooling fluid from the hot-side exhaust port of the heat exchanger to the return port,
whereby, in the heat exchanger, the cold fluid flowing in the cold-side passageways is warmed by the hot fluid flowing in the hot-side passageways, thereby insuring that the cooling fluid supplied to the heat sources is not too cold.

9. A method as claims in claim 8, wherein a heat-source-inlet temperature sensor measures the cooling fluid temperature T₀ in the second piping structure.

10. A method as claimed in claim 9, wherein an N-fold array of heat-source-exhaust temperature sensors measure, in the N-fold array of third piping structure, the temperatures T₁, T₂, . . . , T_{N} of the cooling fluid emerging respectively from the N heat sources.

11. A method as claimed in claim 10, wherein an N-fold array of control valves respectively modulate the flows F₁, F₂, . . . , F_{N} of cooling fluid flowing to the respective N heat sources.

12. A method as claimed in claim 11, wherein a controlling means receives input signals from the heat-source-inlet temperature sensor and the heat-source-exhaust temperature sensors, and on the basis of these N+1 input signals, according to a specified control algorithm, produces N output signals, one of which is received by each of the control valves and causes an opening thereof to be modulated, thereby controlling the flow of cooling fluid to the respective heat source.

13. A method as claimed in claim 8, wherein there is provided a supply temperature sensor that measures coolant temperature T₇ in the first piping structure, wherein is located a three-way valve that switches, in response to a signal from the control means, between a NORMAL configuration and a BYPASS configuration, where the NORMAL configuration causes the cooling fluid to flow from the supply port to the cold-side intake port of the heat exchanger, such that in the NORMAL configuration the temperature T₀ is greater than the temperature T₇, whereas the BYPASS configuration causes the cooling fluid instead to flow from the supply port to the cold-side exhaust port of the heat exchanger, thereby bypassing the heat exchanger, such that in the BYPASS configuration the temperature T₀ is equal to the temperature T₇.

14. A method as claimed in claim 8, wherein said cooling fluid is pre-treated in a single-loop flow cycle to control the temperature of the cooling fluid within specified limits.
